(19) United States
(12) Patent Application Publication
(10) Pub. No.: US 2003/0177023 A1
(43) Pub. Date: Sep. 18, 2003

(54) User registration support system and method for this

(75) Inventor: Yasuo Shibusawa, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/328,747

(22) Filed: Dec. 26, 2002

(30) Foreign Application Priority Data
Dec. 25, 2001 (JP) 2001-391648

(51) Int. Cl. G06F 17/60

(52) U.S. Cl. 705/1; 705/26

(57) ABSTRACT

A user registration support system 10 inputs personal information, which includes an e-mail address specified by a merchandise purchaser at a time of purchasing a commercial article, in a predetermined form for user registration and thereby creates a temporary registration page. The system then transmits a registration support mail, which allows for transmission of a requirement for browsing the temporary registration page, to the specified e-mail address. In response to reception of the requirement for browsing the temporary registration page, the system transmits the temporary registration page to a sender of the browsing requirement in a specific format that allows the sender of the browsing requirement to select one of registration of the temporary registration page without any change, registration of the temporary registration page with modification, and no registration of the temporary registration page.

### BACKGROUND OF THE INVENTION

1. Field of the Invention

The present invention relates to a user registration support system that supports user registration of purchased merchandise, and to a method of the same.

2. Description of the Prior Art

A merchandise purchaser, who has purchased a commercial article, unpacks and sets the commercial article in an available state, prior to actual use. The merchandise purchaser fills required pieces of information including the postal address, the name, and the telephone number in a user registration card, which is packed with the commercial article, and sends the filled-in user registration card by post. The merchandise purchaser otherwise carries out online user registration. The merchandise purchaser is then registered as a legal user in a system of a merchandise dealer or a merchandise manufacturer. The merchandise purchaser registered as the legal user can receive diverse pieces of information relating to the commercial article. A merchandise user may carry out the user registration, when the merchandise user is different from the merchandise purchaser.

The prior art user registration system, however, requires the merchandise purchaser or the merchandise user to take a step to registration, and thus depends upon the merchandise purchaser or the merchandise user. There is no satisfactory system that actively supports user registration for the effective support on the purchased commercial article and the enhanced after-sales service. The user registration should naturally be based on the requirements of the merchandise purchaser or the merchandise user.

The object of the present invention is thus to provide a user registration support system and a method of the same, which actively supports user registration based on a user's requirements.

### SUMMARY OF THE INVENTION

In order to achieve the aforementioned objects, the present invention is a user registration support system utilizing an e-mail, the user registration support system including:

a personal information storage module that stores personal information including an e-mail address specified by a merchandise purchaser at a time of purchasing a commercial article;

a temporary registration page creation module that inputs at least part of the personal information in a predetermined form for user registration and thereby creates a temporary registration page;

a registration support mail transmission module that transmits a registration support mail, which allows for transmission of a requirement for browsing the temporary registration page, to the specified e-mail address;

a browsing requirement receiving module that receives the requirement for browsing the temporary registration page; and

a temporary registration page transmission module that, in response to reception of the requirement for browsing the temporary registration page, transmits the temporary registration page to a sender of the browsing requirement in a specific format that allows the sender of the browsing requirement to select one of registration of the temporary registration page without any change, registration of the temporary registration page with modification, and no registration of the temporary registration page.

This user registration support system inputs part or all of personal information, which includes an e-mail address specified by a merchandise purchaser at the time of purchasing a commercial article, in a predetermined form for user registration and thereby creates a temporary registration page. The system then transmits a registration support mail, which allows for transmission of a requirement for browsing the temporary registration page, to the specified e-mail address. In response to reception of the requirement for browsing the temporary registration page, the system transmits the temporary registration page to a sender of the browsing requirement in a specific format that allows the sender of the browsing requirement to select one of registration of the temporary registration page without any change, registration of the temporary registration page with modification, and no registration of the temporary registration page. This arrangement saves the merchandise purchaser the trouble of filling in the contents for user registration and enables the merchandise purchaser to arbitrarily determine the acceptance or prohibition of the registration after browsing the temporary registration page. The modified contents of the temporary registration page may be registered when the correction of the temporary registration page is required, for example, when the contents of the temporary registration page include any wrong or blank item or when a user other than the merchandise purchaser requires the user registration. This user registration support system thus actively supports the user registration based on the user's requirements.

The user registration support system of the present invention may include a processing execution module that, in response to reception of a reply to the transmission by the temporary registration page transmission module, executes a selected series of processing according to the received reply, so as to carry out one of user registration of current contents of the temporary registration page without any change, user registration of modified contents of the temporary registration page, and no user registration of any contents of the temporary registration page.

In the user registration support system of the present invention, the registration support mail transmission module may transmit the registration support mail, which includes a URL written thereon to be used for access to the temporary registration page on the Internet, to the specified e-mail address, and the browsing requirement receiving module may receive a browsing requirement signal, which is generated by a click of the URL written on the registration support mail.

The user registration support system of the present invention may include an authentication module that authenticates the specified e-mail address as an e-mail address of the merchandise purchaser, wherein the temporary registration page transmission module may transmit the temporary registration page to the sender of the browsing requirement, after the authentication module authenticates the specified e-mail address as the e-mail address of the merchandise purchaser.

Here, the authentication module may transmit a personal information input window to the sender of the browsing requirement to ask the sender of the browsing requirement to input a predetermined piece of the personal information stored in the personal information storage module, receive a reply of the personal information input window with input of the predetermined piece of the personal information from the sender of the browsing requirement, and authenticate the specified e-mail address as the e-mail address of the merchandise purchaser when the predetermined piece of the personal information input by the sender of the browsing requirement is identical with the predetermined piece of the personal information specified at the time of purchasing the commercial article. The predetermined piece of the personal information may be any personal information that enables the merchandise purchaser to be distinguishable from any other people. Available examples of such personal information are the name, the postal address, the birthday, and the telephone number, and the telephone number is preferable.

The present invention is a user registration support method utilizing an e-mail, the user registration support method including the steps of:

(a) inputting at least part of personal information, which includes an e-mail address specified by a merchandise purchaser at a time of purchasing a commercial article, in a predetermined form for user registration and thereby creating a temporary registration page;

(b) transmitting a registration support mail, which allows for transmission of a requirement for browsing the temporary registration page, to the specified e-mail address; and

(c) in response to reception of the requirement for browsing the temporary registration page, transmitting the temporary registration page to a sender of the browsing requirement in a specific format that allows the sender of the browsing requirement to select one of registration of the temporary registration page without any change, registration of the temporary registration page with modification, and no registration of the temporary registration page.

The respective steps of the user registration support method may attain the respective functions of the user registration support system of the present invention discussed above.

### BRIEF DESCRIPTION OF THE DRAWINGS

FIG. 1 schematically illustrates the construction of a user registration support system in one embodiment;

FIG. 2 is a flowchart showing a processing routine of the user registration support program;

FIG. 3 shows an example of temporary registration page;

FIG. 4 shows an example of user registration support mail;

FIG. 5 is a flowchart showing a processing routine of the temporary registration page transmission program;

FIG. 6 shows an example of telephone number input window; and

FIG. 7 is a functional block diagram.

### DESCRIPTION OF THE PREFERRED EMBODIMENTS

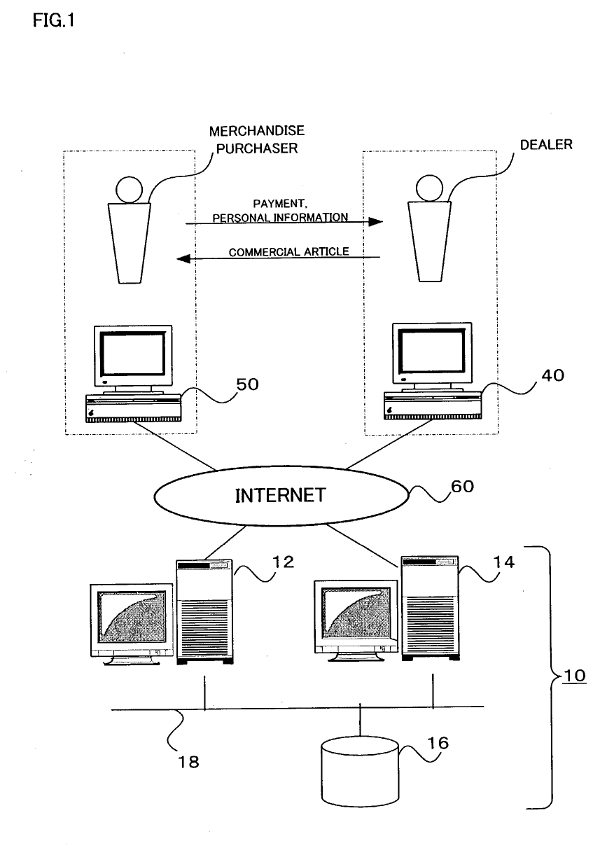

One embodiment of the present invention is discussed below with reference to drawings. FIG. 1 schematically illustrates the construction of a user registration support system 10 in one embodiment.

The user registration support system 10 includes a Web server 12, a mail server 14, and a database server 16. The respective servers 12, 14, and 16 are mutually connected in a communicable manner via a LAN 18. This user registration support system 10 is located in a merchandise sales company, which sells computer-related merchandise including personal computers, printers, scanners, digital cameras, and functions to provide each merchandise purchaser or merchandise user with support services.

The Web server 12 is connected with a dealer computer 40, which is used by a dealer, via the Internet 60 and functions to receive personal information of the merchandise purchaser and information on the purchased commercial article, which are sent from the dealer computer 40. In this embodiment, the ‘personal information of the merchandise purchaser’ includes the name, the postal address, the telephone number, and the e-mail address of each merchandise purchaser. The ‘information on the purchased commercial article’ includes the trade name, the model number, and the serial number of each commercial article purchased by the merchandise purchaser. The Web server 12 is also connected with a purchaser computer 50, which is used by the merchandise purchaser, via the Internet 60 and functions to transmit a Web page required for user registration to the purchaser computer 50 in response to each access requirement from the purchaser computer 50 and to receive an instruction relating to the user registration from the purchaser computer 50.

The mail server 14 functions to send and receive e-mails to and from the dealer computer 40 and the purchaser computer 50. The database server 16 functions to store the personal information of the merchandise purchaser and the information on the purchased commercial article, which are sent from the dealer computer 40, in the form of a database.

Both the dealer computer 40 and the purchaser computer 50 are known general-purpose computers. The dealer computer 40 or the purchaser computer 50 utilizes an installed Web browser to send and receive data to and from the Web server 12 via the Internet 60 and utilizes an installed mailer to send and receive e-mails to and from the mail server 14 via the Internet 60.

The following describes the operations of the user registration support system 10. In this example, it is assumed that the merchandise purchaser visits the dealer and newly purchases a commercial article. As shown in FIG. 1, the merchandise purchaser pays for a desired commercial article, and in return the dealer gives the merchandise purchaser the desired commercial article. The merchandise purchaser fills personal information in a predetermined warranty card for the guarantee of the newly purchased commercial article. The trade name, the model number, and the serial number of the commercial article have been printed on the warranty card. The warranty card also has input boxes for inputting personal information. The merchandise purchaser fills the personal information in these input boxes. The dealer operates the dealer computer 40 to transmit the personal information of the merchandise purchaser who has newly purchased a commercial article and the information on the purchased commercial article to the Web server 12 of the user registration support system 10 via the Internet 60.

The Web server 12 of the user registration support system 10 occasionally receives the personal information of the merchandise purchaser who has newly purchased a commercial article and the information on the purchased commercial article, which are transmitted from the dealer computer 40, via the Internet 60, and transfers the received information to the database server 16 via the LAN 18. The database server 16 temporarily registers the transferred information in the database. The temporary registration in the database is carried out by storing the name, the postal address, the telephone number, and the e-mail address as the personal information of the merchandise purchaser in a format mapped to the trade name, the model number, and the serial number of the purchased commercial article.

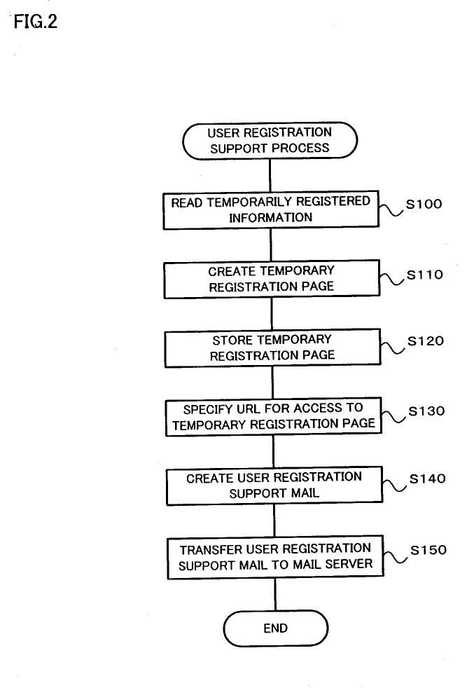

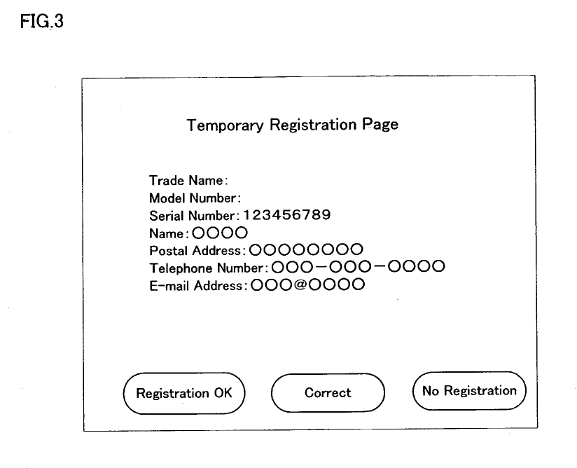

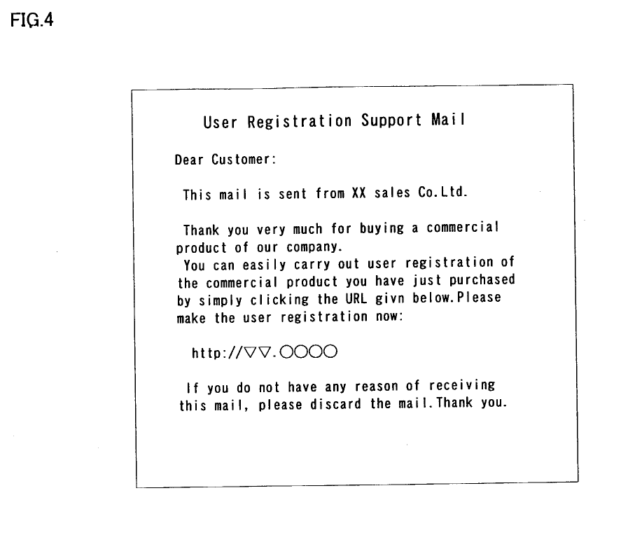

The Web server 12 reads a user registration support program from its own hard disk and starts the program at predetermined timings. FIG. 2 is a flowchart showing a processing routine of the user registration support program. When the processing routine enters this program, the Web server 12 first reads the temporarily registered information from the database server 16 (step S100), and creates a temporary registration page based on the read-out information (step S110). The temporarily registered information includes the name, the postal address, the telephone number, and the e-mail address as the personal information of the merchandise purchaser, in addition to the trade name, the model number, and the serial number of the purchased commercial article. The temporary registration page shown in FIG. 3 is created by inputting all these pieces of information into a preset form for user registration. The Web server 12 then stores the temporary registration page thus created in a predetermined area of its own hard disk (step S120), and specifies a URL (uniform resource locator) of a Web page for access to the temporary registration page (step S130). The Web server 12 subsequently creates a user registration support mail shown in FIG. 4 to the e-mail address included in the temporarily registered information (step S140). The user registration support mail has fixed contents, but the URL for access to the temporary registration page is specified at step S130 and is accordingly varied each time. The Web server 12 finally transfers the created user registration support mail to the mail server 14 (step S150). The processing routine then exits from this program. The mail server 14 transmits the transferred user registration support mail to the e-mail address specified as the destination via the Internet 60.

When the receiver receives this user registration support mail and clicks the URL on the user registration support mail, a Web browser is automatically activated to output a requirement for browsing the temporary registration page to the Web server 12 via the Internet 60.

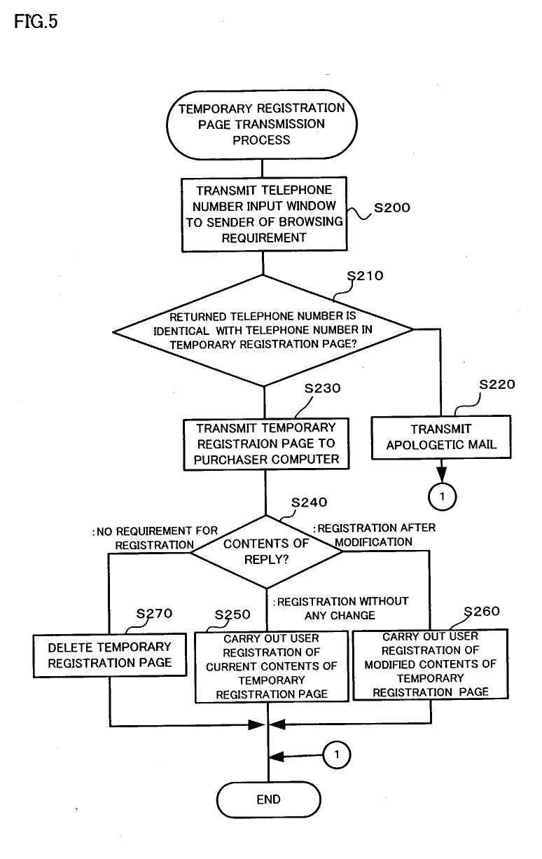

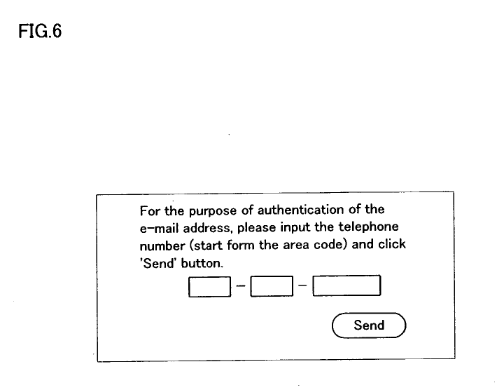

In response to input of the requirement for browsing the temporary registration page, the Web server 12 reads a temporary registration page transmission program from its own hard disk and starts the program. FIG. 5 is a flowchart showing a processing routine of the temporary registration page transmission program. When the processing routine enters this program, the Web server 12 first transmits a telephone number input window (see FIG. 6), which asks to input the telephone number as one piece of the personal information of the merchandise purchaser for the purpose of personal certification, via the Internet 60 to the sender of the browsing requirement (that is, the receiver of the user registration support mail) (step S200). The Web browser of the computer owned by the sender of the browsing requirement receives the telephone number input window. When the sender of the browsing requirement inputs a telephone number in the telephone number input window and clicks a ‘Send’ button, the Web browser returns the telephone number input window with the input telephone number to the Web server 12 via the Internet 60. The Web server 12 compares the telephone number input in the returned telephone number input window with the telephone number described in the temporary registration page, which is the current object of the browsing requirement (that is, the telephone number written at the time of purchasing the commercial article) for the purpose of authentication (step S210). When the two telephone numbers are not identical with each other, it is determined that the e-mail address as the destination of the user registration support mail is not owned by the merchandise purchaser by some reason. The Web server 12 accordingly transmits an apologetic mail, which tells that the previous mail has been sent to the wrong address, to the sender of the browsing requirement (step S220). The processing routine then exits from this program. When the two telephone numbers are identical with each other, on the other hand, it is confirmed that the e-mail address as the destination of the user registration support mail is owned by the merchandise purchaser. Namely the sender of the browsing requirement is determined to be identical with the merchandise purchaser. The Web server 12 accordingly transmits the Web page for access to the temporary registration page to the purchaser computer 50 (step S230).

This Web page includes a section showing the contents of the temporary registration page (the trade name, the model number, the serial number, the name, the postal address, the telephone number, and the e-mail address), a ‘Registration OK’ button, which the merchandise purchases clicks to allow the user registration of the contents of the temporary registration page without any change, a ‘Correct’ button, which the merchandise purchaser clicks to modify the contents of the temporary registration page, and a ‘No Registration’ button, which the merchandise purchaser clicks to prohibit the user registration. The ‘Correct’ button is clicked, when the merchandise purchaser has given the wrong entry or the blank entry at the time of purchasing the commercial article and the current contents include any piece of information to be corrected or to be added, or when the actual merchandise user who is different from the merchandise purchaser desires the user registration.

The Web browser of the purchaser computer 50 receives this Web page, and the merchandise purchaser checks the contents of the temporary registration page. The merchandise purchaser clicks the ‘Registration OK’ button to register the contents without any change. The purchaser computer 50 transmits the acceptance of the registration without any change to the Web server 12. The merchandise purchaser clicks the ‘Correct’ button to modify the contents and register the modified contents The respective input boxes in the temporary registration page fall into the changeable state (that is, in the active state). The merchandise purchaser makes required correction and subsequently clicks the ‘Registration OK’ button. The purchaser computer 50 then transmits the acceptance of the modified registration to the Web server 12. The merchandise purchaser clicks the ‘No Registration’ button to prohibit registration. The purchaser computer 50 then transmits the prohibition of the registration to the Web server 12.

The Web server 12 waits for a reply from the purchase computer 50 and checks the contents of the reply (step S240) to carry out a series of processing according to the contents of the reply. When receiving the acceptance of the registration without any change, the Web server 12 carries out the user registration of the contents of the temporary registration page without any change (step S250). When receiving the acceptance of the modified registration, the Web server 12 carries out the user registration of the modified contents of the temporary registration page (step S260). When receiving the prohibition of the registration, the Web server 12 deletes the temporary registration page (step S270). For the user registration, the database server 16 receives an instruction of user registration from the Web server 12 and rewrites the temporarily registered information, which is the current object of the processing, as the authentic registration. For deletion of the temporary registration page, the database server 16 receives an instruction of deleting the temporary registration from the Web server 12 and deletes the temporarily registered information, which is the current object of the processing. On conclusion of the processing at any of steps S250 through S270, the Web server 12 exits from this program.

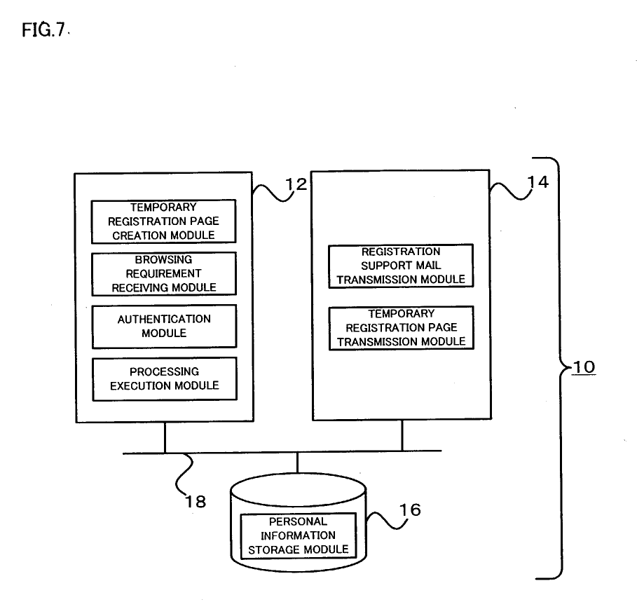

In the user registration support system 10, as shown in the functional block diagram of FIG. 7, the database server 16 functions as the personal information storage module, the Web server 12 functions as the temporary registration page creation module, the browsing requirement receiving module, the authentication module, and the processing execution module, and the mail server 14 functions as the registration support mail transmission module and the temporary registration page transmission module.

The user registration support system 10 of the embodiment described above saves the merchandise purchaser the trouble of filling in the contents for user registration and enables the merchandise purchaser to arbitrarily determine the acceptance or prohibition of the registration after browsing the temporary registration page. The modified contents of the temporary registration page may be registered when the correction of the temporary registration page is required, for example, when the contents of the temporary registration page include any wrong or blank item or when a user other than the merchandise purchaser requires the user registration. This user registration support system 10 thus actively supports the user registration based on the user's requirements. The merchandise purchaser can readily browse the temporary registration page only by clicking the URL written on the received registration support mail.

In the case where the merchandise purchaser has specified a wrong e-mail address at the time of purchasing the commercial article and the registration support mail is sent to a third person other than the merchandise purchaser, the specified e-mail address is not authenticated as the e-mail address of the merchandise purchaser. There is accordingly no fair that the temporary registration page is mistakenly sent to the third person. This arrangement effectively prevents any third person from mistakenly gaining access to the temporary registration page including the personal information.

The embodiment of the present invention discussed above is to be considered in all aspects as illustrative and not restrictive. There may be many modifications, changes, and alterations without departing from the scope or spirit of the main characteristics of the present invention. For example, the user registration support system 10 may be constructed by only one server or by multiple servers, and may include other devices.

The structure of the above embodiment utilizes the telephone number to authenticate the destination of the user registration support page (the specified e-mail address) as the e-mail address of the merchandise purchaser. Another piece of the personal information (for example, the name, the postal address, or the birthday) may be utilized for the purpose of authentication, instead of the telephone number. Another application utilizes a user ID and a password, which are specified at the time or purchasing the commercial article, for the purpose of authentication.

In the structure of the embodiment discussed above, the purchaser computer 50 may be a personal digital assistance, such as a cell phone. The dealer computer 40 may be installed to allow the merchandise purchaser to directly input the personal information.

In the above embodiment, the merchandise purchaser newly purchases a commercial article at the dealer. The principle of the present invention is also applicable to the case where the merchandise purchaser purchases a commercial article in an Internet shopping site. In such cases, the dealer computer 40 does not intervene in transmission of information. But the personal information of the merchandise purchaser and the information on the purchased commercial article are transmitted directly from the purchaser computer 50 to the Web server 12 via the Internet 60.

In the arrangement of the above embodiment, the user registration support process inputs all the pieces of the personal information of the merchandise purchaser in a predetermined form for user registration and then creates the temporary registration page with the input. One possible modification may create the temporary registration page with input of only part of the pieces of the personal information. For example, the temporary registration page may include the input of the name, the postal address, and the telephone number, among all the pieces of the personal information, that is, the name, the postal address, the telephone number, and the e-mail address.

The user registration support system of the embodiment discussed above may be actualized as a computer program. The program may be recorded in a computer readable recording medium (for example, a hard disk, a ROM, an FD, a CD, or a DVD). The program may be transmitted from one computer to another computer via a transmission medium (a communication network like the Internet or a LAN), or may otherwise be provided in any form. A computer included in the user registration support system executes this program and exerts the similar functions and effects to those of the first user registration support system of the present invention.

What is claimed is:

1. A user registration support system utilizing an e-mail, said user registration support system comprising:
a personal information storage module that stores personal information including an e-mail address specified by a merchandise purchaser at a time of purchasing a commercial article;
a temporary registration page creation module that inputs at least part of the personal information in a predetermined form for user registration and thereby creates a temporary registration page;
a registration support mail transmission module that transmits a registration support mail, which allows for transmission of a requirement for browsing the temporary registration page, to the specified e-mail address;
a browsing requirement receiving module that receives the requirement for browsing the temporary registration page; and
a temporary registration page transmission module that, in response to reception of the requirement for browsing the temporary registration page, transmits the temporary registration page to a sender of the browsing requirement in a specific format that allows the sender of the browsing requirement to select one of registration of the temporary registration page without any change, registration of the temporary registration page with modification, and no registration of the temporary registration page.

2. A user registration support system in accordance with claim 1, said user registration support system further comprising:
a processing execution module that, in response to reception of a reply to the transmission by said temporary registration page transmission module, executes a selected series of processing according to the received reply, so as to carry out one of user registration of current contents of the temporary registration page without any change, user registration of modified contents of the temporary registration page, and no user registration of any contents of the temporary registration page.

3. A user registration support system in accordance with claim 1, wherein said registration support mail transmission module transmits the registration support mail, which includes a URL written thereon to be used for access to the temporary registration page on the Internet, to the specified e-mail address, and
said browsing requirement receiving module receives a browsing requirement signal, which is generated by a click of the URL written on the registration support mail.

4. A user registration support system in accordance with claim 1, said user registration support system further comprising:
an authentication module that authenticates the specified e-mail address as an e-mail address of the merchandise purchaser,
wherein said temporary registration page transmission module transmits the temporary registration page to the sender of the browsing requirement, after said authentication module authenticates the specified e-mail address as the e-mail address of the merchandise purchaser.

5. A user registration support system in accordance with claim 2, said user registration support system further comprising:
an authentication module that authenticates the specified e-mail address as an e-mail address of the merchandise purchaser,
wherein said temporary registration page transmission module transmits the temporary registration page to the sender of the browsing requirement, after said authentication module authenticates the specified e-mail address as the e-mail address of the merchandise purchaser.

6. A user registration support system in accordance with claim 4, wherein said authentication module transmits a personal information input window to the sender of the browsing requirement to ask the sender of the browsing requirement to input a predetermined piece of the personal information stored in said personal information storage module, receives a reply of the personal information input window with input of the predetermined piece of the personal information from the sender of the browsing requirement, and authenticates the specified e-mail address as the e-mail address of the merchandise purchaser when the predetermined piece of the personal information input by the sender of the browsing requirement is identical with the predetermined piece of the personal information specified at the time of purchasing the commercial article.

7. A user registration support system in accordance with claim 5, wherein said authentication module transmits a personal information input window to the sender of the browsing requirement to ask the sender of the browsing requirement to input a predetermined piece of the personal information stored in said personal information storage module, receives a reply of the personal information input window with input of the predetermined piece of the personal information from the sender of the browsing requirement, and authenticates the specified e-mail address as the e-mail address of the merchandise purchaser when the predetermined piece of the personal information input by the sender of the browsing requirement is identical with the predetermined piece of the personal information specified at the time of purchasing the commercial article.

8. A user registration support system in accordance with claim 6, wherein the predetermined piece of the personal information is a telephone number.

9. A user registration support system in accordance with claim 7, wherein the predetermined piece of the personal information is a telephone number.

10. A user registration support method utilizing an e-mail, said user registration support method comprising the steps of:
(a) inputting at least part of personal information, which includes an e-mail address specified by a merchandise purchaser at a time of purchasing a commercial article, in a predetermined form for user registration and thereby creating a temporary registration page;
(b) transmitting a registration support mail, which allows for transmission of a requirement for browsing the temporary registration page, to the specified e-mail address; and
(c) in response to reception of the requirement for browsing the temporary registration page, transmitting the temporary registration page to a sender of the browsing requirement in a specific format that allows the sender of the browsing requirement to select one of registration of the temporary registration page without any change, registration of the temporary registration page with modification, and no registration of the temporary registration page.

11. A user registration support method in accordance with claim 10, said user registration support method further comprising the step of:
(d) in response to reception of a reply to transmission of the temporary registration page, executing a selected series of processing according to the received reply, so as to carry out one of user registration of current contents of the temporary registration page without any change, user registration of modified contents of the temporary registration page, and no user registration of any contents of the temporary registration page.

12. A user registration support method in accordance with claim 10, wherein the registration support mail transmitted in said step (b) includes a URL written thereon to be used for access to the temporary registration page on the Internet, and
the browsing requirement in said step (c) is generated by a click of the URL written on the registration support mail.

13. A user registration support method in accordance with claim 10, wherein said step (c) transmits the temporary registration page to the sender of the browsing requirement, after authentication of the specified e-mail address as the e-mail address of the merchandise purchaser.

14. A user registration support method in accordance with claim 11, wherein said step (c) transmits the temporary registration page to the sender of the browsing requirement, after authentication of the specified e-mail address as the e-mail address of the merchandise purchaser.

15. A user registration support method in accordance with claim 13, wherein the authentication of the specified e-mail address as the e-mail address of the merchandise purchaser in said step (c) receives a predetermined piece of the personal information from the sender of the browsing requirement and determines whether or not the predetermined piece of the personal information received from the sender of the browsing requirement is identical with the predetermined piece of the personal information specified at the time of purchasing the commercial article.

16. A user registration support method in accordance with claim 14, wherein the authentication of the specified e-mail address as the e-mail address of the merchandise purchaser in said step (c) receives a predetermined piece of the personal information from the sender of the browsing requirement and determines whether or not the predetermined piece of the personal information received from the sender of the browsing requirement is identical with the predetermined piece of the personal information specified at the time of purchasing the commercial article.

17. A user registration support method in accordance with claim 15, wherein the predetermined piece of the personal information in said step (c)is a telephone number.

18. A user registration support method in accordance with claim 16, wherein the predetermined piece of the personal information in said step (c) is a telephone number.
